(19) United States
(12) Patent Application Publication
(10) Pub. No.: US 2025/0340357 A1
(43) Pub. Date: Nov. 6, 2025

(54) DEVICES AND METHODS FOR PORTABLE ENVIRONMENT CONTROLLED CONTAINERS

(71) Applicant: PAVEL & SPRAUVE LLC, Walnut Creek, CA (US)

(72) Inventors: Steven S. ESCOBAR, San Jose, CA (US); Michael SPRAUVE, San Jose, CA (US); Michael PAVEL, Walnut Creek, CA (US); Guoqiang LI, San Jose, CA (US)

(73) Assignee: PAVEL & SPRAUVE LLC, Walnut Creek, CA (US)

(21) Appl. No.: 19/266,249

(22) Filed: Jul. 11, 2025

Related U.S. Application Data
(63) Continuation of application No. PCT/US24/15089, filed on Feb. 9, 2024.
(60) Provisional application No. 63/483,983, filed on Feb. 9, 2023.

(51) Int. Cl. B65D 81/18; A45C 11/20; B65D 81/26; H05B 1/02

(52) U.S. Cl. CPC B65D 81/18; A45C 11/20; B65D 81/263; H05B 1/0252; B65D 2313/02

(57) ABSTRACT

Portable and reconfigurable containers for delivering food products from a central location to a remote location are disclosed. More specifically, the disclosure relates to portable containers for delivering food products operable to maintain an environment for the food product during the delivery process.

### CROSS-REFERENCE

This application is a continuation of PCT Application PCT/US24/15089 filed Feb. 9, 2025, which claims the benefit of U.S. Provisional Application No. 63/483,983, filed Feb. 9, 2023, entitled METHODS, SYSTEMS, AND DEVICES FOR PORTABLE ENVIRONMENT CONTROLLED CONTAINERS which applications are incorporated herein in their entirety by reference.

### BACKGROUND

Field. The disclosure relates to portable containers for delivering food products from a central location to a remote location. More specifically, the disclosure relates to portable containers for delivering food products operable to maintain an environment for the food product during the delivery process.

Background. The United States does nearly $50B (USD) per year in restaurant food delivery. This number is projected to reach over $90B per year in the United States and over $160B per year globally by 2023. With the global pandemic COVID-19 in 2019, an even faster growth in the food delivery space is likely.

As the rate of food delivery increases, the expectation for quality and taste by the consumer will also increase. Effort are being made to improve the quality of the delivered food at the delivery destination to match, or substantially match, the quality of the food at the creation location. Current solutions focus on maintaining the heat of the to-be-delivered food. However, heat alone does not overcome the degradation in the quality of food during the delivery process.

What is needed are methods, systems and devices for portable environment-controlled containers suitable for food delivery which enable delivered food to maintain the quality and experience of the in-restaurant experience.

### SUMMARY

Disclosed are methods, systems and devices for portable environment-controlled containers suitable for food delivery which enable delivered food to maintain the quality and experience of the in-restaurant experience. The systems and devices are configurable to control a plurality of environmental factors to facilitate the maintenance of the food temperature and humidity. What is also needed are methods, systems and devices for monitoring an environmental condition and reporting a change in condition which does not require opening the container. What is also needed are tools to customize the environmental conditions based on the type of food being transported.

Disclosed are portable containers. Suitable portable containers comprise: an enclosure having an openable section, the openable section operable to move from an open position, for receiving a container, and a closed position; an environmental control module interface surface which can be removably incorporated into a surface of the portable container; an environmental control module operable to engage the environmental control module interface surface; one or more environmental controllers; one or more environmental sensors; and a power supply, wherein the environmental control module is operable to communicate one or more sensed environmental conditions and to adjust one or more environmental controllers. The containers and/or enclosures have a three-dimensional shape selected from a cube, a cuboid, a pyramid, a cone, a triangular prism, and a cylinder. The one or more environmental sensors are selected from temperature sensors, moisture sensors, humidity sensors, atmospheric pressure sensors, oxygen sensors, air quality sensors, smoke sensors. Additionally, more than one of any of the environmental sensors can be provided. In some configurations, the one or more environmental sensors positioned within the environmental controller. Further, the one or more environmental sensors positioned within the portable container at a location away from the environmental controller. A GPS sensor can also be provided in some embodiments. A communication device can also be provided for transmitting information from one or more sensors and receiving environment control instructions in response to the transmitted sensor information. One or more of a GPS sensor and a G-force sensor can also be provided.

Another embodiment is directed to transportation methods comprising: providing a portable container having an enclosure having an openable section, the openable section operable to move from an open position, for receiving a food container, and a closed position, an environmental control module interface surface incorporated into a surface of the portable container, an environmental control module operable to engage the environmental control module interface surface, one or more environmental controllers, one or more environmental sensors, and a power supply, wherein the environmental control module is operable to communicate one or more sensed environmental conditions and to adjust one or more environmental controllers; opening the portable container; placing the food container within the portable container for transport; closing the portable container; configuring the environmental control module to maintain an environment within the container based on an identification of food within the food container; and transporting the portable container. The methods can also comprise one or more of determining a GPS location for the portable container, determining a G-force for the portable container, determining if the portable container has maintained one or more environmental conditions during transport, and if the portable container has maintained the one or more environmental conditions, delivering the food container, determining if the portable container has been subjected to any G-force during transport, and if the portable container has not been subjected to any G-force, delivering the food container, and determining if the portable container has been subjected to any G-force during transport, and if the portable container has been subjected to any G-force, determining whether the G-force is within a predetermined range of allowable G-force, and if the G-force is within the predetermined range of allowable G-force, delivering the food container.

Thermally insulated delivery bags or environment control containers are disclosed. The thermally insulated bag can be soft-sided and, for example, take the shape of a pizza bag. The thermally insulated bag can also be hard-sided and can take any shape appropriate for the delivery of the prepared food for delivery. The thermally insulated bags are operable to measure and regulate an internal temperature and moisture content (humidity) of thermally insulated delivery bag via the use of sensors, fans, heaters, and software.

On one side of thermally insulated bag there is a hard-sided enclosure, the environmental controller, that contains the hardware and software that enables The Environment control container to function. There is a PCBA that acts as the “control center” of the device, via communication with an app that runs on a user's phone or on a dashboard, accessed via the web, which controls the operation of the fans, heaters, sensors, communications, etc.

Inside thermally insulated bag, associated with the top and bottom layers, are wire-coil heaters that are operable to serve as a primary heat source for thermally insulated bag. When the environmental controller is secured to thermally insulated bag, the heating coils are connectable via leads to the environmental controller and power is provided to the heating coils via the environmental controller. One or more of each of a humidity sensor and a temperature sensor can be provided within the interior of the thermally insulated bag or attached to the environmental control center, which connects to and receives power.

The environmental controller can be provided with two fans. A first fan is operable as an exhaust fan, and a second fan is operable as an intake fan. The intake fan can also include a coil-heater mounted within the fan to enable the intake of heated air into the interior of thermally insulated bag. The coil heater can be a third heater. This intake fan heater is typically used when preheating thermally insulated bag and when the internal temperature of thermally insulated bag drops below a preset threshold and the intake fan heater acts as a “booster” to return the temperature to within threshold more quickly than would otherwise happen via the heaters positioned within the thermally insulated bag.

An exhaust fan is typically employed to extract moisture, generated as steam from the food, from thermally insulated bag. Any fan enclosures provided are equipped with flaps or louvres, which are in a closed position, due to gravity, when a fan is not in use, thereby sealing an opening in thermally insulated bag through which it could lose heat. When a fan is engaged, the force of the air pushes the louvers open, and the air passes thru.

Multiple power sources can be provided. For example, Lithium-Ion battery (contained within the enclosure), 120 v standard wall outlet, 12 v car cigarette lighter can be used without departing from the scope of the disclosure. The use of multiple power sources is operable to maximize battery life for any batteries provided. For example, when in the restaurant awaiting orders for delivery, The thermally insulated bag can, for example, be plugged into a standard 120V wall outlet for preheating. While in transit on foot or scooter thermally insulated bag can operate to maintain the environment within thermally insulated bag within target parameters from the battery power alone and while in a vehicle, for example, thermally insulated bag can be plugged into the cigarette lighter for power.

Still another aspect of the disclosure is directed to a system comprising one or more of: memory; one or more processors; and one or more computer-executable instructions stored in the memory and executable by the one or more processors to perform operations comprising: receiving, via a mobile application associated with a service provider on a device, a current geographic location of the device; receiving, via the mobile application associated with the service provider on the device, one or more environmental conditions; determining if the portable container has maintained one or more environmental conditions within an environmental condition range during transport, and if the portable container has maintained the one or more environmental conditions, delivering food container located within the portable container; displaying, via the mobile application, instructions to deliver the food container if the environmental conditions have been maintained. Additionally the system can be operable to determine if the portable container has been subjected to any G-force during transport, and if the portable container has not been subjected to any G-force, delivering the food container and/or determine if the portable container has been subjected to any G-force during transport, and if the portable container has been subjected to any G-force, determining whether the G-force is within a predetermined range of allowable G-force, and if the G-force is within the predetermined range of allowable G-force, delivering the food container.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 6,281,477 B1 by Forrester et al. issued Aug. 28, 2001;
U.S. Pat. No. 6,297,481 B1 by Gordon issued Oct. 2, 2001;
U.S. Pat. No. 6,353,208 B1 by Bostic et al. issued Mar. 5, 2002;
U.S. Pat. No. 8,168,923 B2 by Wong et al. issued May 1, 2012;
U.S. Pat. No. 9,492,035 B2 by Pavel et al. issued Nov. 15, 2016;
U.S. Pat. No. 10,049,236 B1 by Alkarmi et al. issued Aug. 14, 2018;
U.S. Pat. No. 10,207,804 B1 by Gentry issued Feb. 19, 2019;
U.S. Pat. No. 10,321,263 B1 by Alkarmi et al. published Jun. 11, 2019;
U.S. Pat. No. 11,449,818 B2 by Escobar et al. issued Sep. 20, 2022;
US 2015/0374177 A1 by Pavel et al. published Dec. 31, 2015;
US 2017/0265687 A1 by Veltrop et al. published Sep. 21, 2017;
US 2018/0061207 A1 by Nygren et al. published Mar. 1, 2018;
US 2019/0112119 A1 by Alexander et al. published Apr. 18, 2019;
US 2019/0337706 A1 by Vain et al. published Nov. 7, 2019;
US 2020/0051015 A1 by Davis et al. published Feb. 13, 2020;
US 2020/0229645 A1 by Karsten et al. published Jul. 23, 2020;
US 2022/0044188 A1 by Escobar et al. published Feb. 10, 2022;
GB 2374918 A by Reece published Oct. 30, 2002;
CN 203723974 U published Jul. 23, 2014;
EP 1580145 A1 by Martini published Sep. 28, 2005;
JP 2009285130 A by Ito et al. published Dec. 10, 2009;
KR 20110011575 A published Feb. 8, 2011;
WO 1995/020535 A1 by Ghirardi published Aug. 3, 1995;
WO 2020/037370 A1 by Valance published Feb. 27, 2020;
WO 2020/046385 A1 by Pointer et al. published Mar. 5, 2020;
WO 2022/031897 A1 by Escobar et al. published Feb. 10, 2022; and
Labuza et al., Moisture Migration and Control in Multi-Domain Foods, Trends in

Food Science and Tech, 9(2): 47-55 (1998).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-K illustrate an environment control container;

FIGS. 2A-B illustrate the environment control container with an open front flap;

FIGS. 3A-E illustrate the environment control container with components separated and compiled;

FIGS. 4A-F illustrate another environment control container with components separated and compiled;

FIGS. 5A-D illustrates a bottom pouch insertable into the environment control container along with the power supply and heating element insert;

FIGS. 6A-D illustrates a top pouch insertable into the environment control

container along with the heating element insert;

FIGS. 7A-E illustrate pouch placement in the environment control container with components separated and compiled;

FIG. 8 illustrates a block diagram of component parts of the system including the environment control containers;

FIG. 9 illustrates an exemplar process flow for managing an environment within the device; and

FIGS. 10A-G illustrate an exemplar power tree.

### DETAILED DESCRIPTION

### I. Devices

Environment control containers according to the disclosure can be a thermally insulated bag and include, for example, one or more radiant heaters, an air heater, an intake fan, an exhaust fan, a humidity sensor, a temperature sensor, one or more louvers, a power supply, a printed circuit board, a Bluetooth transmitter, a cellular transmitter, and a GPS tracker or transponder.

One radiant heater can be located inside the upper/top wall of thermally insulated bag in a sleeve. A second heater can be provided that is located in the bottom/lower wall of thermally insulated bag in a sleeve. The heaters are used for heating up thermally insulated bag as well as maintaining the internal temperature of thermally insulated bag within a preset range while in transit.

A forced air heater can be provided that is part of an intake fan system. The forced air heater can, for example, be located on the rear of thermally insulated bag (e.g., a side of thermally insulated bag opposing an opening when the opening is located on the side of thermally insulated bag). The forced air heater can be part of a hard-case enclosure that removably engages the back of thermally insulated bag (e.g., snaps onto thermally insulated bag or is secured by hook and loop flaps). It is a radiant heater attached to a fan that draws air into thermally insulated bag. Air passes over the forced air heater, thereby heating the air as the air enters the interior of the thermally insulated bag. The forced air heater can also heat thermally insulated bag itself as well as provide supplemental support for the radiant heaters when in transit. During use, if the internal temperature of thermally insulated bag falls below a lower temperature threshold, the intake fan and forced air heater are operable to turn-on in response to the sensed temperature and operable to return the internal temperature of the thermally insulated bag to a temperature within a preset or optimal temperature range. This adjustment of temperature using the forced air heater enables temperature to more quickly return to a temperature within the preset or optimal temperature range than if heat were controlled solely with the radiant heaters.

The exhaust fan can, for example, be located at the rear of thermally insulated bag on the opposite side of the hard case enclosure or environmental controller and the intake fan or forced air heater. The exhaust fan is used for regulating the moisture content of the air inside thermally insulated bag during transit. If the humidity level inside the thermally insulated bag increases beyond a preset limit, the exhaust fan turns on and evacuates the moist air from thermally insulated bag. Once the humidity level drops back to within range, the exhaust fan turns off.

Sensors are provided including, for example one or more of each of humidity sensor and temperature sensor. Placement of sensors can be, for example, at the rear of thermally insulated bag. Sensor can be operable to take continuous readings or near continuous readings and then transmit the readings real-time or near real-time to the printed circuit board assembly, which engages and disengages the heaters and fans pursuit to a target humidity or humidity range and/or a target temperature or temperature range.

Horizontal or vertical flaps can be provided (e.g., louvers). The flaps can be formed from, for example, silicone or a similar material. The flaps are positionable over the one or more of each of an intake fan and an exhaust fan. The flaps prevent heat from escaping from thermally insulated bag when the fans are not turned on (e.g., when the fans are in an off state). When the fans are turned on, the flaps open slightly from the force of the fan and allow passage of air through an aperture retaining the fan. When the fans turn off, the flaps close and seal off the opening to the aperture housing the fans. The opening and closing of the flaps occurs when air is forced onto the flaps and closes when air is no longer forced onto the flaps.

Suitable power supplies include one or more of each of: batteries, wall plugs (e.g., electrical outlets, electrical sockets, plugs and/or wall plugs), and cigarette lighter power supply (e.g., by plugging the device into a car lighter). For proper use, it is plugged into the wall for preheating, about 10-20 mins. While in transit thermally insulated bag can be powered by batteries and/or plugged into a car lighter port for supplemental power.

One or more printed circuit board (PCB) can be provided. The PCB can be mounted within the hard case at the rear of the device. The PCB is operable to house the components used to manage the operation of the sensor, fans and heaters as well as communication hardware for transmitting data.

A Bluetooth transmitter can also be provided. The Bluetooth transmitter is enclosable within the hard case. The Bluetooth transmitter transmits data from the environment control container to, for example, a phone or other Bluetooth device. Data comprises, for example, temperature, humidity, GPS location, time, G-force shocks, battery status, etc.

A cellular transmitter can be provided that can be enclosed within the hard case as well. The cellular transmitter can be used to transmit data. The cellular transmitter can, for example, transmit data when a Bluetooth device is unavailable.

A GPS tracker/transponder can also be provided. The GPS tracker can be enclosed within the hard case. The GPS tracker is operable to transmit the location data of the device via the available Bluetooth or cellular transmitters. The GPS tracker allows for real-time or near real-time tracking of the location of each environment control container.

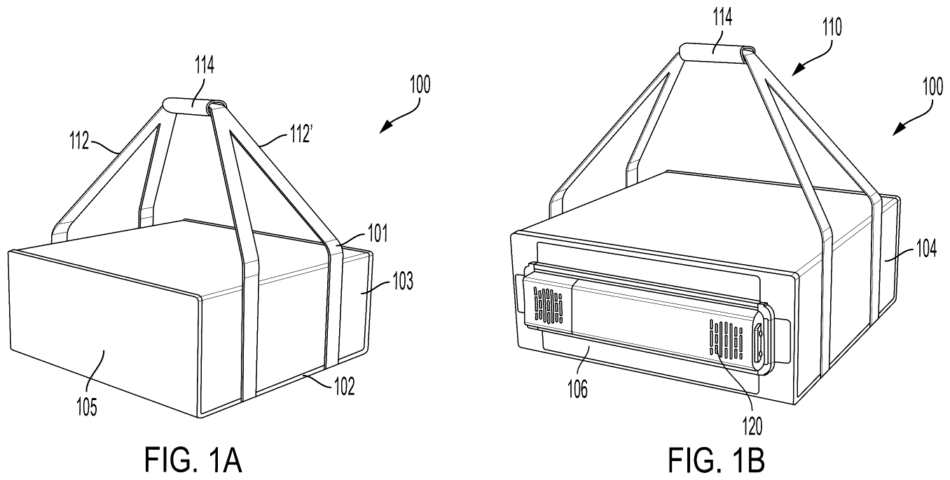

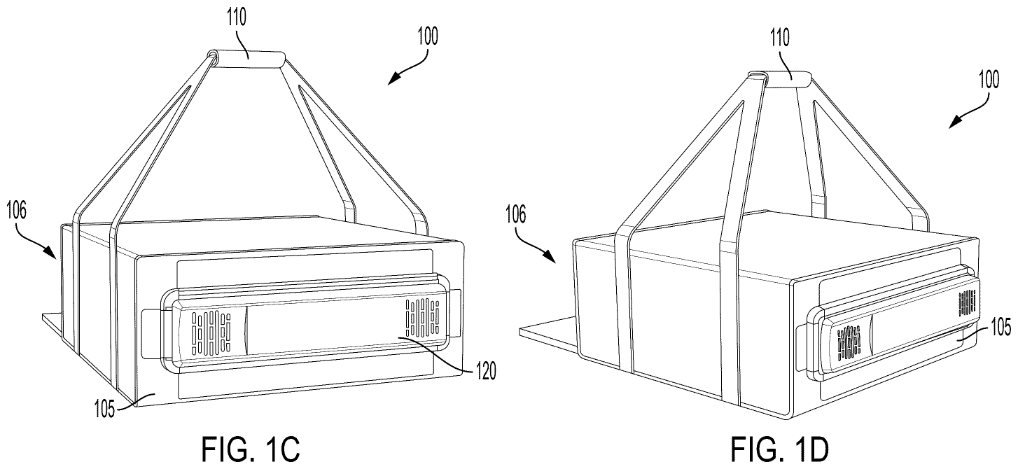

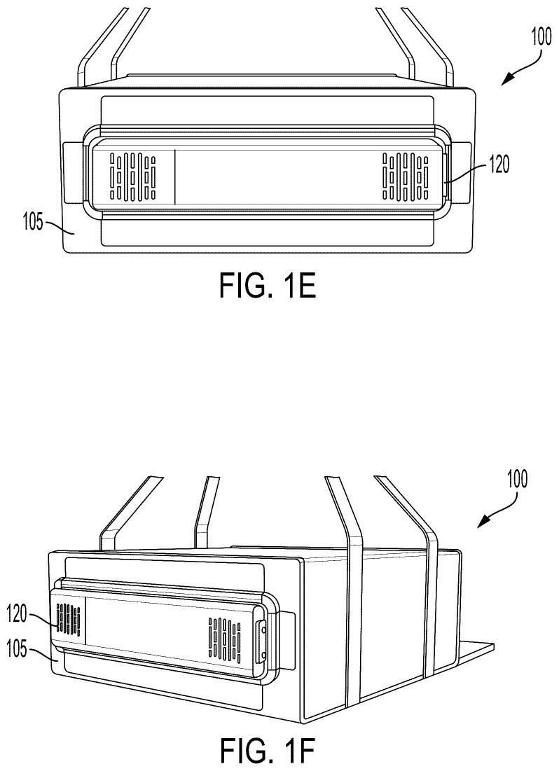

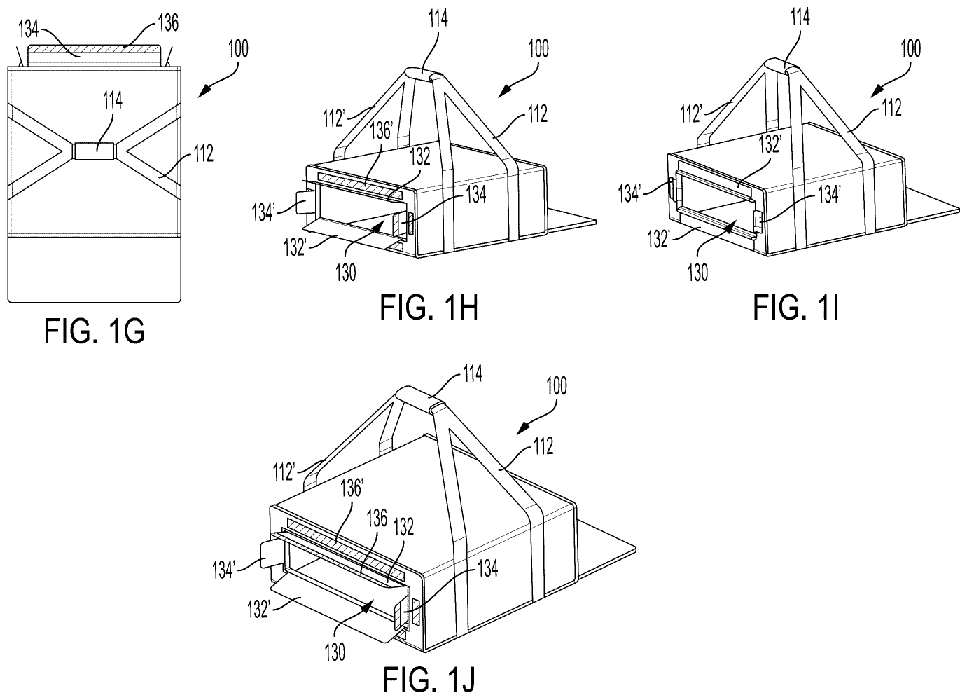

Turning now to a specific embodiment an environment control container 100 illustrated in FIGS. 1A-K an environment control container 100 is illustrated. The environment control container 100 is operable to house a container therein having an environmentally fragile content, such as a food item. The environment control container has interior surfaces and exterior surfaces and defines an interior cavity. As will be appreciated by those skilled in the art, humidity is a parameter that ovens, for example, have no control over. Humidity comprises water molecules and water molecules conduct heat much faster than air. Thus, humid air transfers heat more efficiently to food. During the cooking process, humidity can result in food cooking more quickly while also preventing water in the food from evaporating. An additional impact on temperature is air pressure. Temperature affects air pressure at different altitudes due to a disparity in air density. Thus the overall optimal environment can be impacted by a variety of different environmental conditions. The exterior dimensions of the environment control containers disclosed herein are configurable to have a first dimension of from 15 inches to 25 inches (e.g., width), a second dimension of from 15 inches to 25 inches (e.g., length), and a third dimension of from 3 inches to 15 inches (e.g., depth). The interior dimensions of the environmental control containers disclosed are less than the exterior dimensions of the containers.

FIGS. 1A-B illustrate perspective views of an exemplar of the environment control container 100 from a first end and a second end with the first end being closed and the second end having an environmental controller 120. The container 100 has a three dimensional shape defining an interior space into which an item for which environmental control is desired can be placed. The environmental controller 120 is removable.

As illustrated in FIGS. 1A-F, the environmental control container 100 has a top side 101, a bottom side 102, a first side 103, a second side 104, a third side 105 and a fourth side 106. As will be appreciated by those skilled in the art, the sides can be referred to as front, rear, right and left sides without departing from the scope of the disclosure. As will be appreciated by those skilled in the art, although the environment control container 100 is shown with an opening for receiving a container (e.g., third side 105) and an opening for securing the controller (e.g., fourth side 106), any side can be used for those purposes without departing from the scope of the disclosure.

The first container of the environment control container 100 is made from an insulating material. Moreover, the first container of the environment control container 100 can have a plurality of flexible or semi-flexible sides and an interface surface for engaging the environmental controller 120. One of the sides can be an opening side, allowing access to the interior of the environment control container 100. As illustrated, the fourth side 106 is configured to removably secure the environmental controller 120.

The environment control container 100 can be made of a material that allows the device to wick moisture from the inside of the enclosure to the outside of the enclosure. Moreover, the environment control container 100 can be comprised of one or more panels made from a substantially flexible material. In other configurations, the environment control container 100 can be made from one or more panels having a rigid or partially rigid shape (e.g. skeleton) to allow for stacking multiple environment control container 100.

The environment control container 100 can have a square or rectangular shape in a first dimension, e.g., along an upper surface having a handle 110 and a square or rectangular shape in a second dimension. The handle 110 can be provided operable to facilitate carrying the environment control container 100 to facilitate optimal orientation of the environment control container 100, for example, two straps 112, 112′. As illustrated, each strap engages the side of the first container (exterior container) of the environment control container 100. As will be appreciated by those skilled in the art, the straps 112, 112′ can connected on the sides of the first container of the environmental control container, as illustrated, or along the opening side and the opposing rear side without departing from the scope of the disclosure. As illustrated, the third side 105 engages the environmental controller 120. Additionally, a holder 114 can be provided which secures the two straps 112, 112′ together. The holder 114 can be a separate holder element or can be incorporated into one of the straps 112, 112′ to facilitate securing the straps together.

The environmental controller 120 can be positioned on any surface of the environment control container 100 without departing from the scope of the disclosure. As illustrated the environmental controller 120 is secured to a side wall of the environment control container 100.

The interior space or chamber can be sized to receive a second container (interior container) which is further sized to receive a plurality of containers, such as pizza boxes, and take-out food containers. As will be appreciated by those skilled in the art, the exemplar shape provided in the figures is one that is suitable for, for example, a pizza box. However, other shapes can be employed without departing from the scope of the disclosure. For example, three-dimensional shape can be selected from cube, cuboid, pyramid, cone, triangular prism, and cylinder Additionally, the location of the opening could, in some configurations, be positioned along the upper surface (where the handles are located in the illustrations) and the removable controller could also be positioned at another location without departing from the scope of the disclosure. One or more of the surfaces can be soft-sided. At least one surface, or a portion thereof, is configured to engage an environmental controller 120.

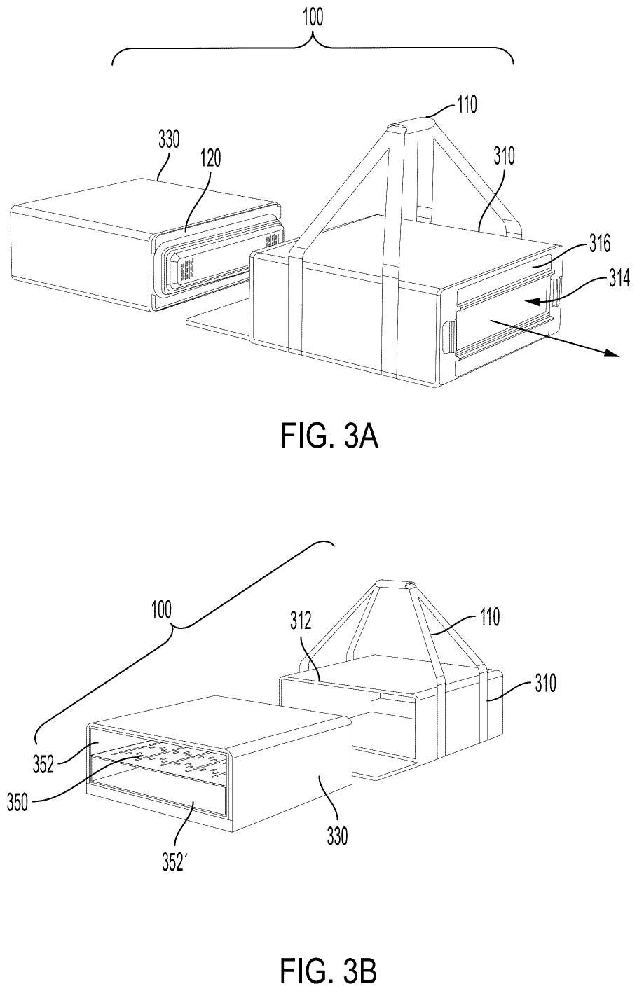

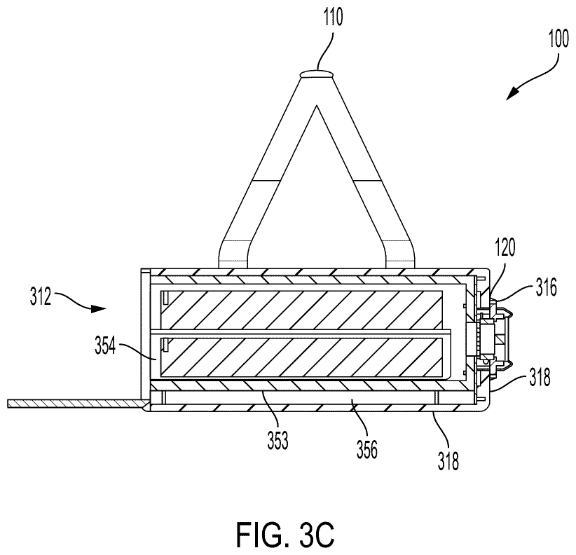

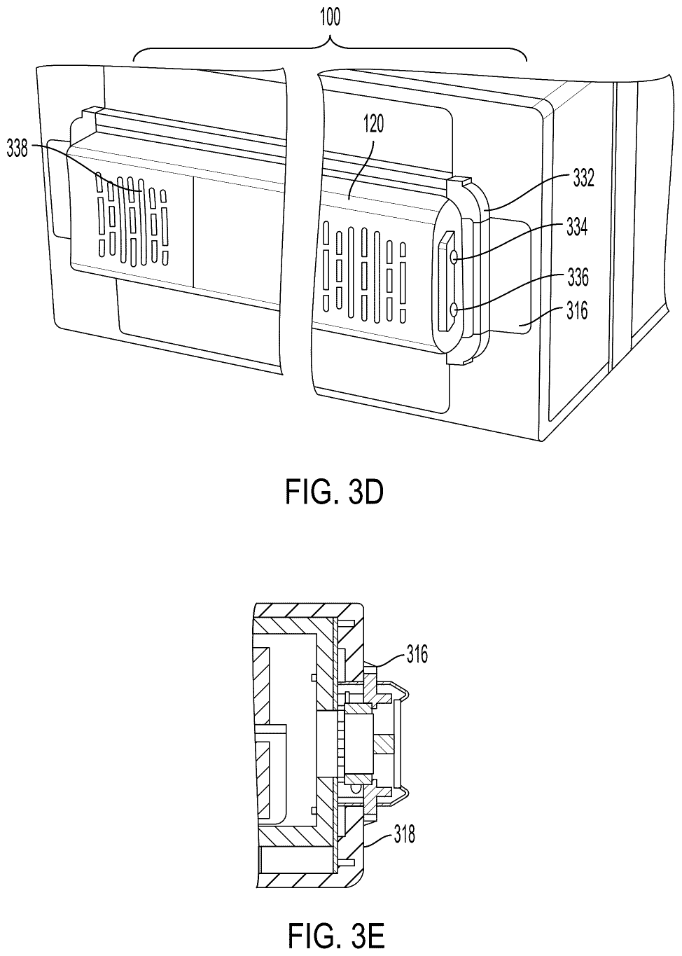

FIG. 1G is a top view of the environment control container 100 with the front side open. FIG. 1H and FIG. 1J are perspective views of the environment control container 100 from a rear surface view with the front side open and the aperture for retaining the second container. Flaps are shown in an open configuration. FIG. 1I is a perspective view of the environment control container 100 also from a rear surface view with the front side open and the aperture for retaining the second container. In this configuration, the hook and loop fastener (e.g., Velcro®) is folded back onto the surface of the environment control container. FIG. 1K shows the exterior container of the environment control container with an opening 130 (e.g., square or rectangular) on the back of the container operable to engage the environmental controller. An upper flap 132 and a lower flap 132′ is provided on each of two opposing sides of the opening 130. Providing the upper flap 132 and lower flap 132′ on, for example, the long side of the opening 130 when the opening 130 has a rectangular shape as illustrated provides additional strength when the interior chamber is engaged with the exterior container. Two additional side flaps 134, 134′ can also be provided on the opening 130 when the opening is rectangular in shape. Each of the flaps (e.g., upper flap 132, lower flap 132′, and side flaps 134, 134′) can be provided with a length of, for example, one half of a hook and loop fastener 136, which, when any of the flaps are folded back towards environment control container 100 into a secured position, will engage a mating length of a second half of the hook and loop fastener 136′. The length of the hook and loop fastener on either the exterior surface of the environment control container 100 or the flaps (e.g., upper flap 132, lower flap 132′, and side flaps 134, 134′) can correspond to the length of the side of the opening where the hook and loop fastener is secured, or can be less than the length of the side of the opening or a plurality of fastener lengths applied in series along a side of the opening. The flaps (e.g., upper flap 132, lower flap 132′, and side flaps 134, 134′) pass through a space or gap between the retainer 332 (shown in FIG. 3D) and the removable environmental controller 120 to allow the flap (e.g., upper flap 132, lower flap 132′, and side flaps 134, 134′) to fold back onto the exterior surface of the exterior container of the environment control container, thereby locking the hook fastener surface to the loop fastener surface and securing the environmental controller 120 to the environment control container 100.

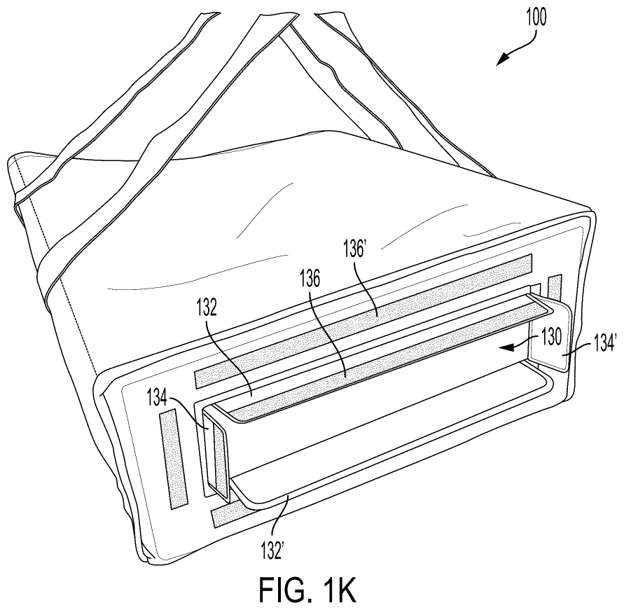

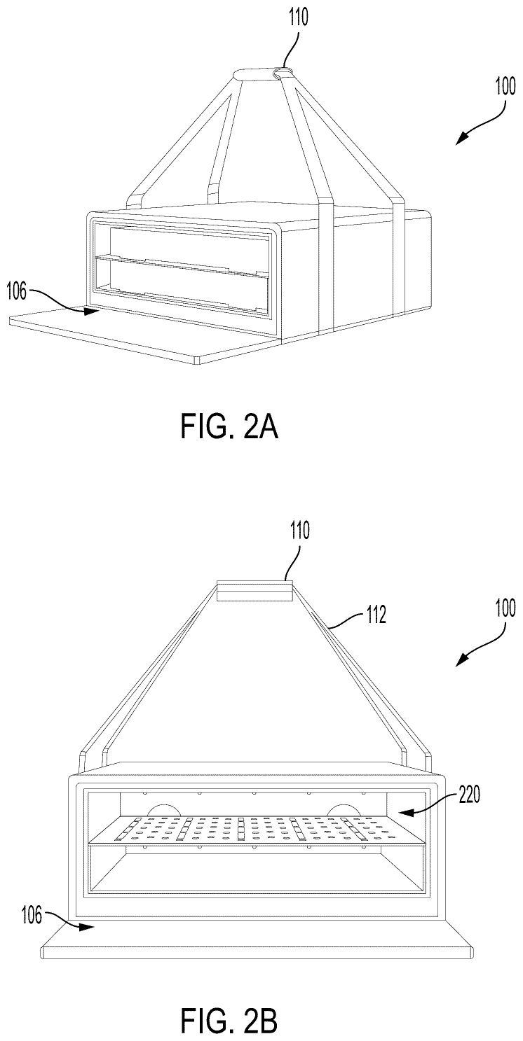

FIGS. 2A-B illustrate the environment control container 100 with an open front flap on the fourth side 106. The interior 220 of the container can be all metal and include a shelf as described below in FIG. 3. FIG. 2A illustrates, for example, two pizza boxes positioned within the interior of the environment control container 100.

FIG. 3A-C illustrates the environment control container 100. The environment control container 100, has a first container 310 and a second container 330. The first container 310 can be a bag with flexible sides and the second container 330 can be an oven assembly with rigid sides and a shelf. The second container 330 is installed into the first container 310 by the motion shown with the arrow 301. Each of the first container 310 and the second container 330 has a first side, a second side, a front side, a back side, a top side and a bottom side. The first container 310 is sized to hold the second container 330 within an interior cavity through an opening 312 accessible on a side of the first container 310, such as the front side. The environmental controller 120 is securable to the second container 330 on a side and interacts with an aperture 314 on a side of the first container 310, such as the back side. One or more hook and loop fastener 316, such as Velcro®, are provided on the surface of the first container adjacent the aperture 314. The hook and loop fasteners 316 can be positioned adjacent the aperture 314 and can be used to removably secure the second container 330 to the first container 310.

As shown in FIGS. 3D-E, the hook and loop fasteners 316 passes around a retainer 332 and loops back onto itself for securing the second container 330. The face of the environmental controller 120 is configurable to have a charging jack 334 and a power switch 336. Recesses 338 and a plurality of apertures 340 on the front surface of the environmental controller 120 facilitate airflow between an intake and an exhaust. The intake 342 and the exhaust 344 can be positioned on opposing ends of the environmental controller 120.

Turning back to FIG. 3B, the first container 310 is shown with the front flap open and the second container 330 positioned to be slidably received into the interior of the first container 310. The first container 310 is soft-sided while the second container 330 is hard sided. The interior of the second container 330 has a shelf 350 that separates the interior of the second container 330 into two chambers 352, 352′. The second container 330 can also include a further insulation layer 353. The two chambers can be positioned one on top of the other (as illustrated) or side by side. The surface of the shelf 350 can have a plurality of apertures to allow air flow between the two chambers 352, 352′.

FIG. 3C is a cross-sectional view of the environmental controller container 100 with the second container 330 positioned within the first container 310. The first container 310 has a foam layer 318 and an exterior material layer 320. The foam layer 318 can be selected to provide an insulation layer and/or a layer to prevent damage to the second container 330. The second container 330 has a heater 354. A power supply 356, such as a rechargeable battery, is provided on the lower surface of the second container 330. Positioning the battery on the lower surface allows the weight of the battery to be spread out along the container and balances the weight of the environmental controller 120 to allow thermally insulated bag to remain in a horizontal orientation-whereas positioning the battery adjacent or incorporated into the environmental controller 120 could result in a weight imbalance that could cause the environmental controller container 100 to list thereby potentially reorienting the food container positioned within the environment control container 100.

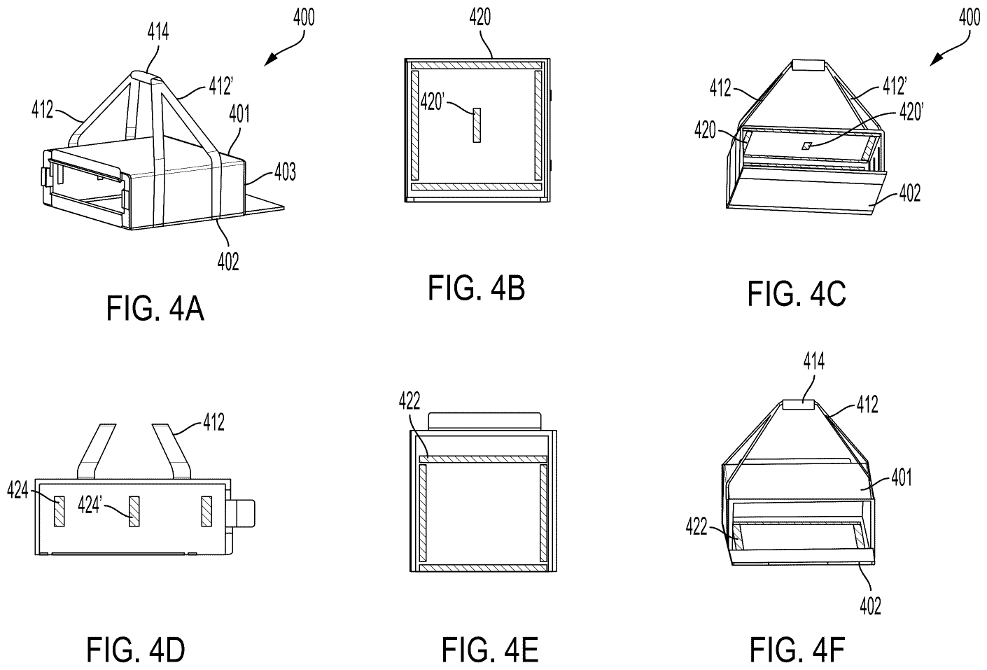

FIGS. 4A-F illustrate another environment control container 400 with components separated and compiled. The environment control container has interior surfaces and exterior surfaces and defines an interior cavity or chamber. As illustrated, the environment control container 400 is a portable soft-sided bag. The environmental controller 120 shown above in FIGS. 1 and 3 can be secured to the environment control container 400 at a fourth side 406, the fourth side 406 is configured to removably secure the environmental controller 120.

As discussed above, the environmental controller 120 can have one or more of an intake, exhaust, heater, sensor(s), fan(s), global positioning system (GPS), printed circuit board (PCB), wifi and memory.

FIG. 4A illustrates the environment control container 400 from a rear perspective view and the front flap opposite the rear opening in an open configuration where the rear surface is operable to engage the environmental controller 120 and the front surface is operable to open/close to receive a content within the interior of the environment control container. A holder 414 can be provided which secures the two straps 412, 412′ together. The holder 414 can be a separate holder element or can be incorporated into one of the straps to facilitate securing the straps together.

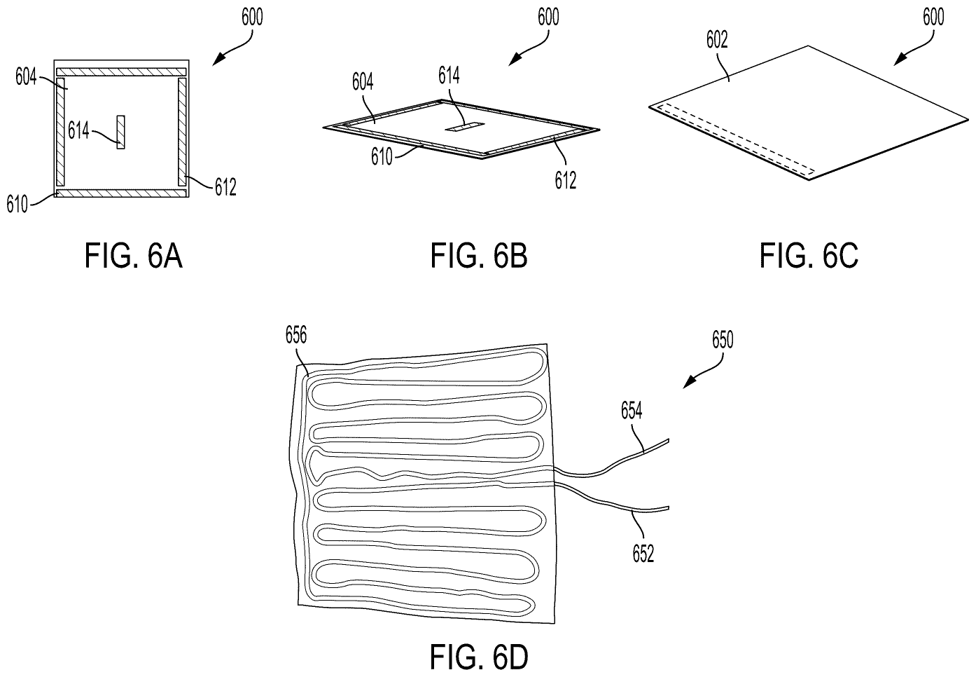

FIG. 4B illustrates an internal facing surface of the top side 401 of the environment control container 400. A plurality of strips 420, 420′ of a hook and loop fastener are provided to removably secure components. As illustrated, one or more strips 420 are positioned along or near an outer edge of the internal facing surface of the top side 401 and one or more separate strips 420′ are positioned centrally on the internal facing surface of the top side 401. The internal facing fasteners are operable to secure a removable first pouch (e.g., FIG. 6) to the upper internal facing surface.

FIG. 4D illustrates a cross-sectional side view of the environment control container 400. The interior surface of the side wall 403 has a plurality of strips of hook and loop fasteners 424, 424′. As will be appreciated by those skilled in the art, the opposing side wall of the environment control container 400, although not shown, can also feature a plurality of strips of hook and loop fasteners positioned at or near an opposing location. The interior side wall hook and loop fasteners 424, 424′ are operable to secure a shelf within the interior of the environment control container 400.

One or more shelves similar to shelf 350 shown in FIG. 3B can be provided. The one or more shelves can be made of metal, vinyl or any other suitable material operable to separate the interior of the environment control container 400 into two or more sections where each section is operable to receive a container of food. Other mechanisms of securing the one or more shelves within the interior of the environment control container 400. A shelf can be provided with a length of mating hook and loop fastener positioned to engage the hook and loop fastener on the interior side wall 424, 242′ above and/or below the position of the shelf after insertion. In another configuration, the interior of the environment control container 400 can include one or more flanges, flaps, or ridges extending from the interior surface of the side wall. The one or more flanges, flaps or ridges can be positioned to either allow a single shelf to be positioned at different locations within the interior of the environment control container 400, or allow more than one shelf to be positioned within the interior of the environment control container 400 to create different cavities for receiving food and/or food containers. The one or more flanges, flaps or ridges can further include a length of hook and loop fastener on a surface operable to mate with a length of hook and loop fasteners along a length. In another configuration, where the environment control container 400 is formed from a flexible material, the interior surface or an interior surface layer can be formed with one or more flexible flaps on either side of the interior surface. Each of the one or more flexible flaps could then include a length of hook and loop fastener on an upward facing surface operable to mate with a length of hook and fastener on a lower surface of one or more shelves. In another configuration, a two or more lateral strips having a width and a thickness can be applied to the interior surface to provide a ledge on which the shelf rests. Ledges can be formed from, for example, foam insulation tape having a width of ½ inch and a thickness of ¼ inch that is adhered to the interior surface of the device. The ledge can be placed on two opposing sides of the device and along the front opening. Additionally, the two or more ledges can be one continuous piece along a side or multiple, shorter, pieces along each side.

FIG. 4E illustrates an internal facing surface of the bottom side 402 of the environment control container 400. A plurality of strips 422 of a hook and loop fastener are provided. As illustrated, one or more strips 422 are positioned along or near an outer edge of the internal facing surface of the bottom side 402 and one or more separate strips 420′ are positioned centrally on the internal facing surface of the top side 401.

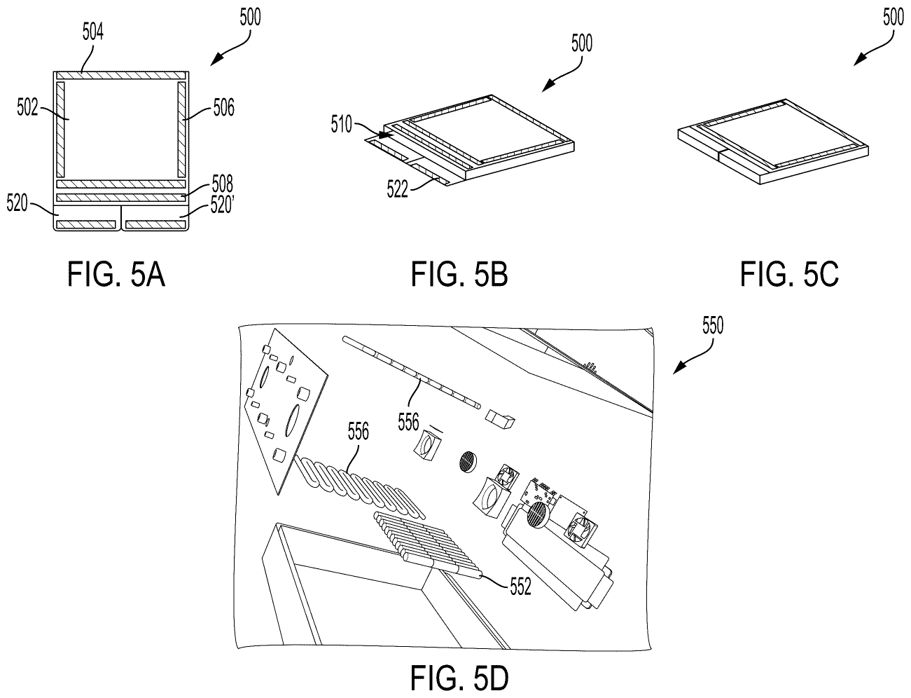

FIG. 4F is a partial perspective front view of the environment control container 400 from a perspective opposite the perspective shown in FIG. 4A showing the interior facing surface of the bottom side 402. The internal facing fasteners are operable to secure a removable second pouch (e.g., FIG. 5) to the lower internal facing surface.

FIGS. 5A-C illustrates a bottom pouch 500 insertable into the environment control container 400 shown in FIG. 4. The bottom pouch 500 can have a length, a width and a height and defines an interior cavity 510 or chamber. The interior cavity 510 is operable to receive one or more of a heating element and a battery pack. An exterior facing lower surface 502 has one or more strips of bottom pouch hook and loop fasteners 504, 506. The one or more strips of bottom pouch hook and loop fasteners can be positioned at or near the sides of the bottom surface of the bottom pouch 500 and positioned to correspond, or substantially correspond to the one or more strips 422 positioned along or near an outer edge of the internal facing surface of the bottom side 402 of the environment control container 400 shown in FIG. 4E.

The exterior dimensions of the bottom pouch 500 disclosed herein are configurable to have a first dimension of from 14.75 inches to 24.75 inches (e.g., width), a second dimension of from 14.75 inches to 24.75 inches (e.g., length), and a third dimension of from 1.0 inches to 2.0 inches (e.g. height). The dimension of the bottom pouch 500 can be optimized to fit snuggly within the interior dimension of the environment control container.

One side of the bottom pouch 500 is openable via one or more side flaps 520, 520′. The one or more side flaps 520, 520′ can have one or more strips of side flap hook and loop fasteners 522. When the one or more side flaps 520, 520′ are brought into a closed configuration, the side flaps can be secured to a length of the parallel hook and loop fastener 522 on the bottom surface resulting in the closed configuration shown in FIG. 5C.

FIG. 5D illustrates an exploded view of an insert 550 for insertion into the bottom pouch 500. The insert has, for example, a planar battery pack 552 positioned within a housing 554. The planar battery pack is operable to provide power to the environment control container and also provides a balanced weight along a bottom surface of the environment control container during transport to case carrying and avoid tipping of the environment control container and its contents. The battery pack can include a plurality of batteries and an electrical connection to the controller (e.g., environmental controller 120 in FIG. 1). A heating element 556 can also be provided that is thermally separated from the battery pack. Control of the heating element 556 can be via the environmental controller 120 which is operable to control amount and length of time heat is delivered.

FIGS. 6A-C illustrates a top pouch 600 insertable into the mobile environment control container shown in FIG. 4. The top pouch 600 is substantially planar with a smooth interior facing surface 602 (shown in FIG. 6C), and a fastener surface 604. The top pouch fastener surface 604 has one or more strips of fastener surface hook and loop fasteners 610, 612. A central fastener surface hook and loop fastener 614 can also be provided to correspond to the hook and loop fasteners positioned on the interior facing surface of the environment control container 400. The top pouch 600 has an interior cavity sized to receive a heater 650 (shown in FIG. 6D). The exterior dimensions of the bottom pouch 500 disclosed herein are configurable to have a first dimension of from 14.75 inches to 24.75 inches (e.g., width), a second dimension of from 14.75 inches to 24.75 inches (e.g., length), and a third dimension of from 0.5 inches to 1.5 inches (e.g. height). The dimension of the bottom pouch 500 can be optimized to fit snuggly within the interior dimension of the environment control container.

The heater 650 has a heating element 652 encased in a packaging envelope 658. The heating element 652 can be insulated to prevent becoming flammable. The heating element 652 can be formed using, for example, a mesh of polyester filament and micrometal conductive fiber folded in a protective polyimide film. Wires 654, 656 arc provided in electrical communication with the power source, e.g. battery pack. Control of the heating element 652 can be via the environmental controller 120 which is operable to control amount and length of time heat is delivered.

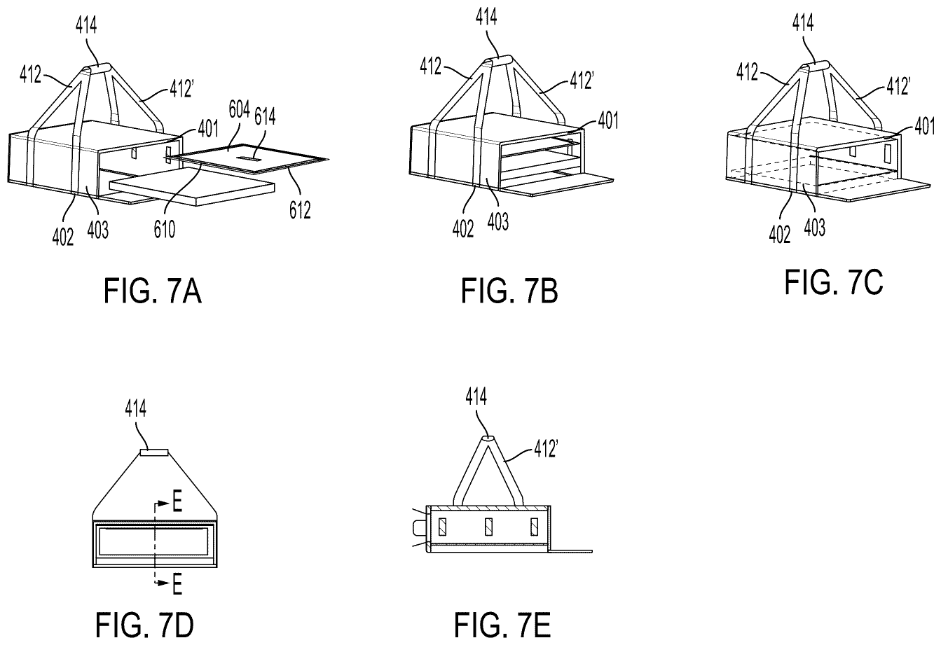

FIGS. 7A-E illustrate pouch placement for the pouches in FIGS. 5 and 6 in the environment control container 400 shown in FIG. 4 with components separated and compiled. The use of the removable pouches allows the one or more heating elements and the battery pack to be easily moved between environment control containers. Thus, for example if an environmental control container becomes worn or damaged, the internal components contained in the pouches and the controller can be moved to a new environmental control container.

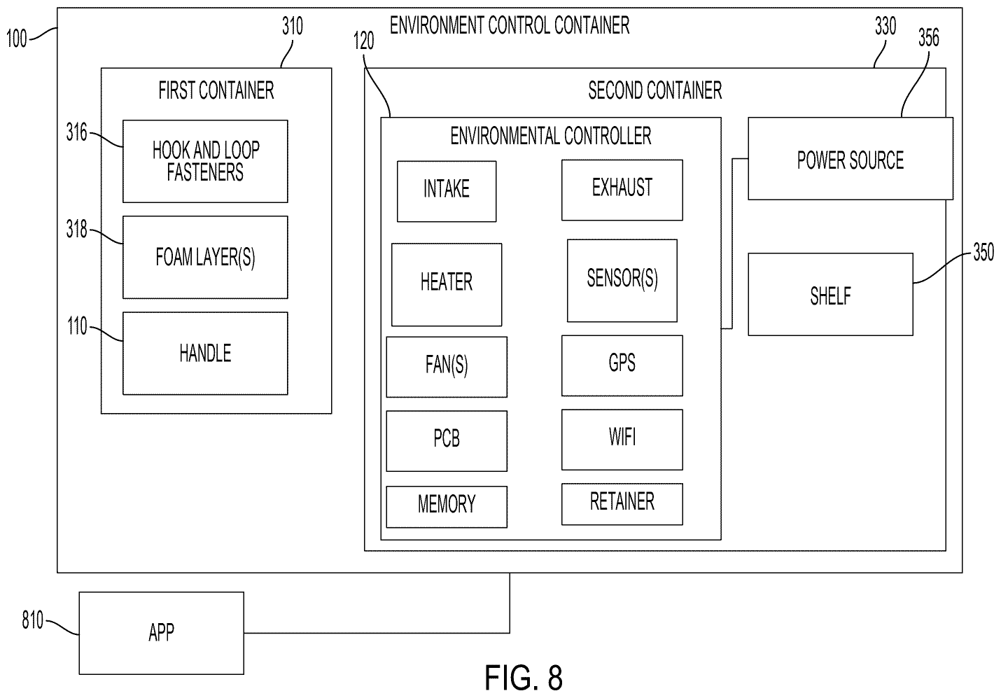

FIG. 8A is a block diagram showing the components of the environment control container 100, including the first container 310 with the hook and loop fastener(s) 316, foam layer(s) 318, and handle 110, and the second container 330 with the environmental controller 120, power supply 356 and shelf 350. The environment control container 100 is in communication with a software application, software app 810, which can provide control information to the environment control container 100. Additional the environmental controller 120, can have one or more of an intake, exhaust, heater, sensor(s), fan(s), global positioning system (GPS), printed circuit board (PCB), wifi and memory. As will be appreciated by those skilled in the art, the environment control container 100 can also be environmental control container 400. FIG. 8B is a block diagram showing the components of the environment control container 400.

### II. Methods

One or more fans can be mounted on one or more heating elements to force heated air over the contents of the environment control container 100, 400. A PCB can be provided which is configurable to control the one or more heating elements and the one or more fans based on a feedback from, for example, a moisture sensor and/or a heat sensor. One or more sensors can be part of the environmental controller 120 or incorporated into another surface of the container, e.g. at a location away from the one or more fans and one or more heaters, to ensure that the farthest locations within the container have a heat and/or humidity that is desired. Where a thermal pad or liner is used, thermal pad or liner can provide heat to the interior of the environment control container. The heat delivered by thermal pad or line can still be controllable by the environmental controller 120.

An app can be used to monitor the conditions within the environment control container 100, 400 and/or control the environment within the container without opening the container. The app can also be used to alert of a malfunction or environment change. Thus, the app can be used, for example, to control and/or monitor temperature and moisture settings, monitor power levels and/or battery usage, and the like. Additionally, it may be desirable to monitor G forces. Monitoring the G force can, for example, be used to prevent delivering a damaged item to the purchaser. The app can be used on any suitable electronic device including cell phones and tablets.

In some configurations, the app that controls the conditions within the container can be part of a secondary device, such as a mobile phone, or it can be part of an integrated interface accessible to the user on the outside of the container.

Additionally, one or more displays can be provided which enable a user to determine an on/off condition for the container and/or a power supply status (e.g. battery level, power source plugged in, charging status, etc.). The app or software product can also transmit its location and internal settings, as well as external conditions, via mobile connection to a cloud controller which is configured to monitor one or more mobile devices.

Using the software app 810 or the dashboard, the environment control container is set to target heat and humidity parameters, depending on such factors as type of food, outside weather conditions, quantity of food in the environment control container, etc. These parameters can be chosen from a preconfigured menu or can be customized. Example settings could be: Temperature Range: 75 C-80 C; and Humidity Range: 11%-13%.

Once environment control container is turned on, the environment control container will begin preheating, using, for example, all three heaters, to a temperature within the desired temperature range. Once the environment control container reaches the lower temperature of the temperature range, the intake fan heater shuts off to conserve power. Once the temperature reaches the upper temperature of the temperature range, the internal heaters turn off. Once the temperature drops below the upper end of the temperature range, one or both (depending on the settings) of the internal heaters in the environment control container turns back on. If the temperature drops below the lower threshold temperature, then the intake fan heater engages until the temperature within the interior of the environment control container returns to a temperature within the temperature range. This temperature control cycle continues for as long as the environment control container is on, and the system operates to maintain the temperature within the desired range.

Similar to the control of the temperature, the humidity is managed by use of the exhaust fan, which turns on when the humidity in the environment control container exceeds the upper limit of the humidity range. The fan turns off once the humidity drops back to the lower limit of the humidity range. This humidity control process continues for as long as the environment control container is on and operates to maintain the humidity within the desired range. The humidity control function operates to extend the food quality over time. As will be appreciated by those skilled in the art, food quality is impacted by the level of moisture in food. Over time, food subjected to heat or warming dries out which causes a deterioration of the quality of food. By monitoring and controlling the humidity within the container the amount of time within which the quality of the food is maintained is extended which provides additional time for delivery of food without negatively impacting the quality. For example, the time within which food can be delivered without significant loss of quality can exceed an hour whereas current solutions often have a serious degradation of quality of the food in less than 30 minutes,

### III. Systems

FIGS. 8A-8B illustrate system overviews. The system can have a first container 310 and a second container 330 in communication with an environmental controller 120 and a software app 810. Alternatively, the system can have a container with a first pouch or bottom pouch 500 and a second pouch or top pouch 600 in communication with the environmental controller 120. A series of hook and loop fasteners can be provided to secure the container in a closed configuration and to secure the pouches to an interior surface of the container.

A software app interfacing 810, monitoring and/or controlling the system can be configured to achieve a variety functions. For example, the software app can track and log delivery times and distances, and track and lock an internal temperature at various times throughout the delivery process (e.g., a start, at delivery and/or at times during the delivery process). A dashboard can be provided that allows the operator/owner to see a location, settings, and/or conditions of the container. Settings may also be changed remotely via the app. Settings that can be changed or monitored can include, for example, on/off, temperature, moisture content, accelerometer readings, and battery life. Additionally, the app can be configured to “sleep” (or hibernate) if there has been no activity for a period of time, or to “wake” when movement is sensed.

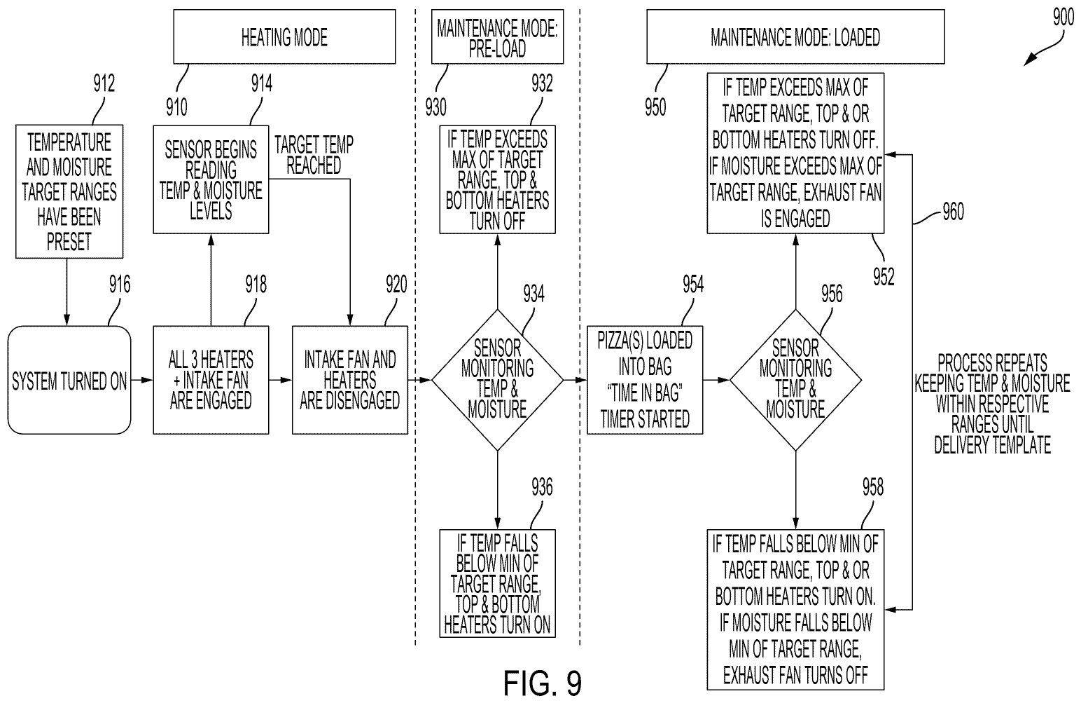

FIG. 9 illustrates an exemplar process flow 900 for managing an environment within an environment control container as disclosed herein. The process flow 900 has three modes: heating mode 910, pre-loaded maintenance mode 930, and loaded maintenance mode 950. The heating mode 910 begins with a preset of one or more of a temperature range and a moisture range 912. Once the device goes into heating mode 910, the system is turned on 916. Once the system is turned on 916, one or more of up to three heaters is turned on and the intake fan is engaged 918. One or more sensors begin reading one or more of temperature and moisture (or humidity) within the interior of the device 914. When the pre-set target temperature is reached, or a temperate within the pre-set range is reached, the intake fans and one or more of up to three heaters is turned off 920 or disengaged. Once the system is disengaged, the system can transition to pre-loaded maintenance mode 930. During pre-loaded maintenance mode, one or more sensors monitor one or more of temperature and moisture within the interior of the device 934. If the temperature exceeds a maximum temperature of the pre-set target temperature range 932 one or more of the interior heaters is turned off and/or adjusted to a lower temperature. If the temperature falls below a minimum temperature of the pre-set target temperature range 936 one or more of the interior heaters is turned on and/or adjusted to a higher temperature.

Once the pre-load maintenance conditions 930 are met, the system can proceed to the loaded maintenance mode 950. During the loaded maintenance mode 950, the food item (e.g., pizza) is loaded into the interior of the device 954 and a timer is started. During loaded maintenance mode 950, one or more sensors monitor one or more of temperature and moisture within the interior of the device 956. If the temperature exceeds a maximum temperature of the pre-set target temperature range 952 one or more of the interior heaters is turned off and/or adjusted to a lower temperature. If the temperature falls below a minimum temperature of the pre-set target temperature range 958 one or more of the interior heaters is turned on and/or adjusted to a higher temperature. The process of monitoring and engaging and/or adjusting the one or more heaters and fans is continued to maintain the temperature and moisture within the respective ranges until delivery is complete.

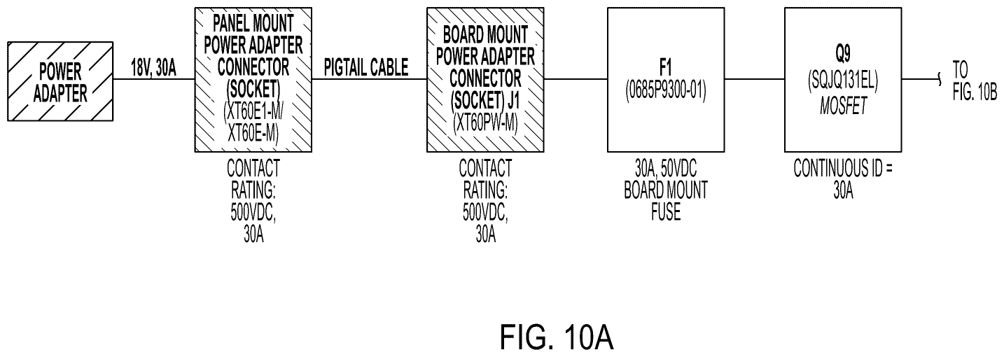

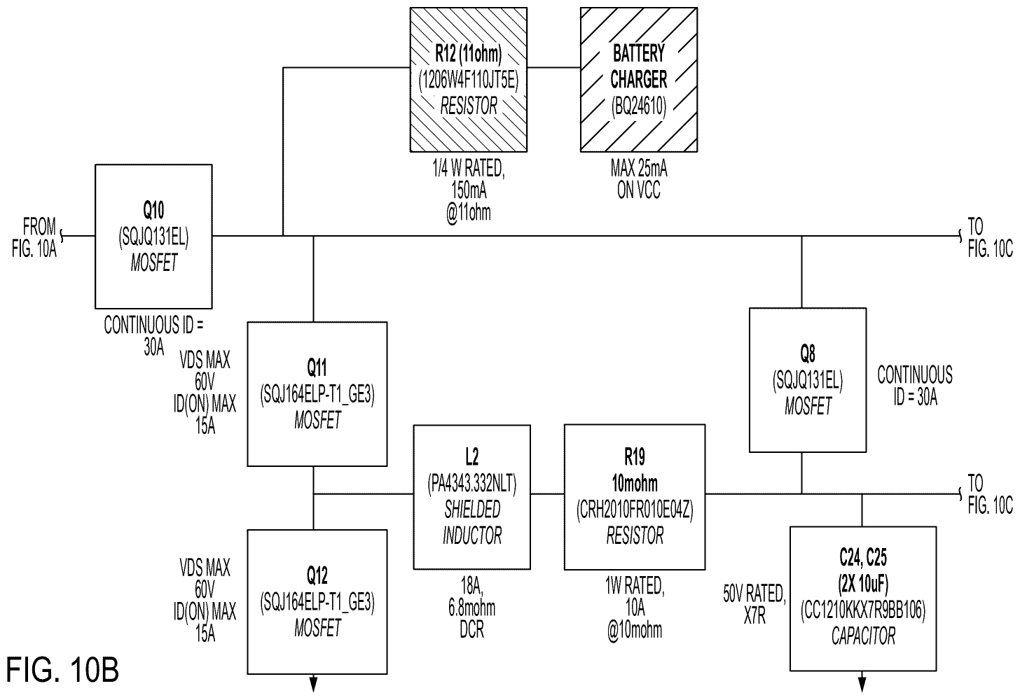

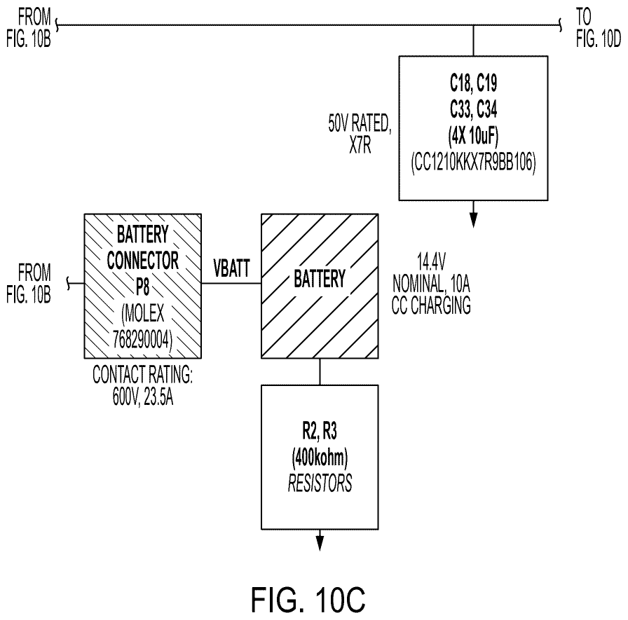

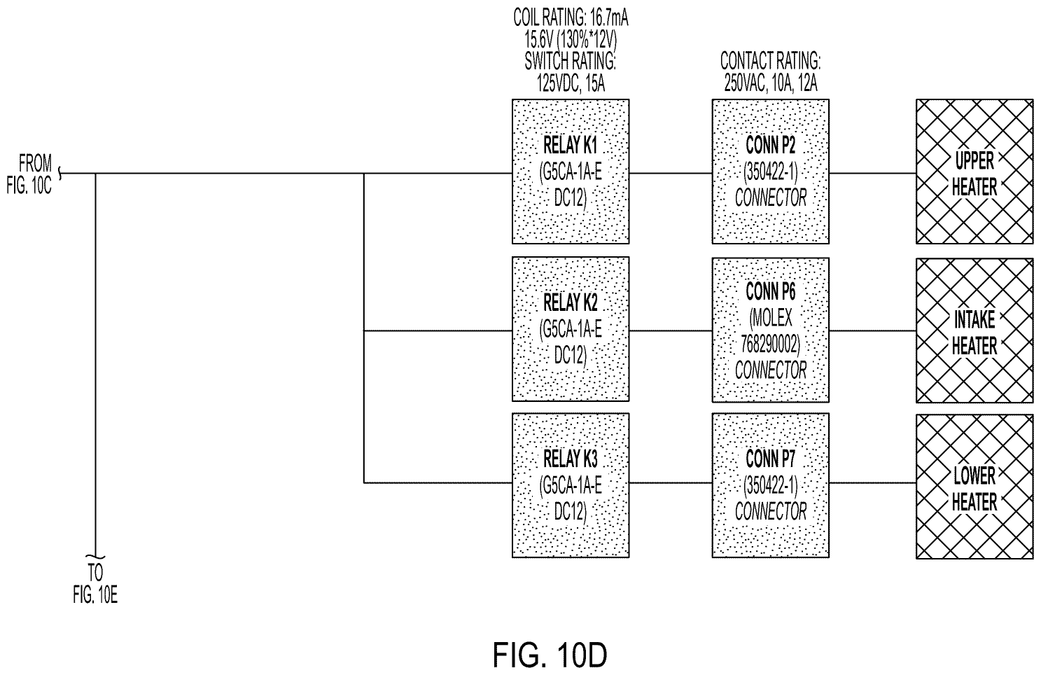

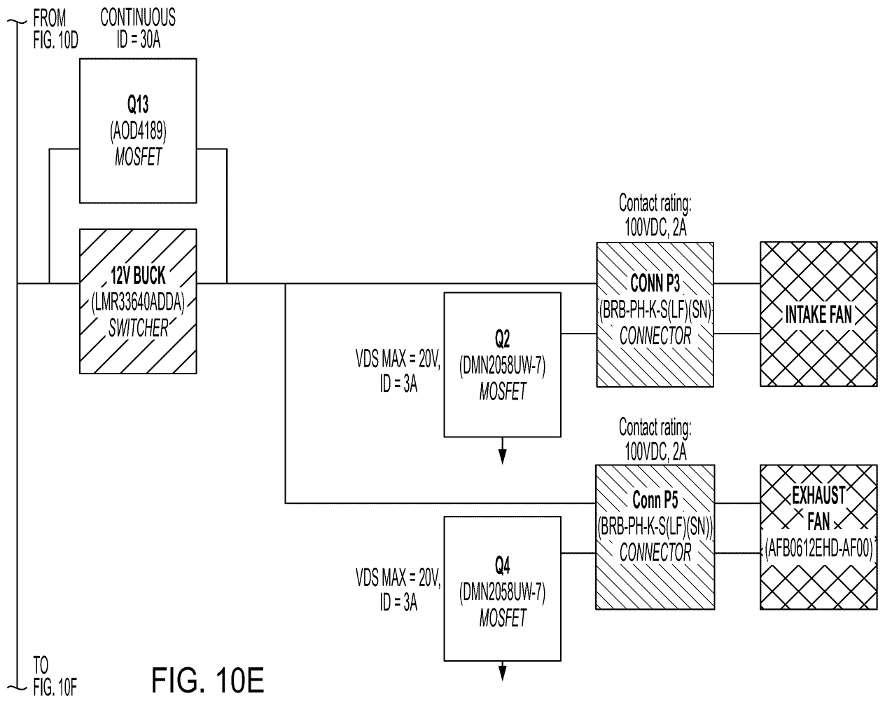

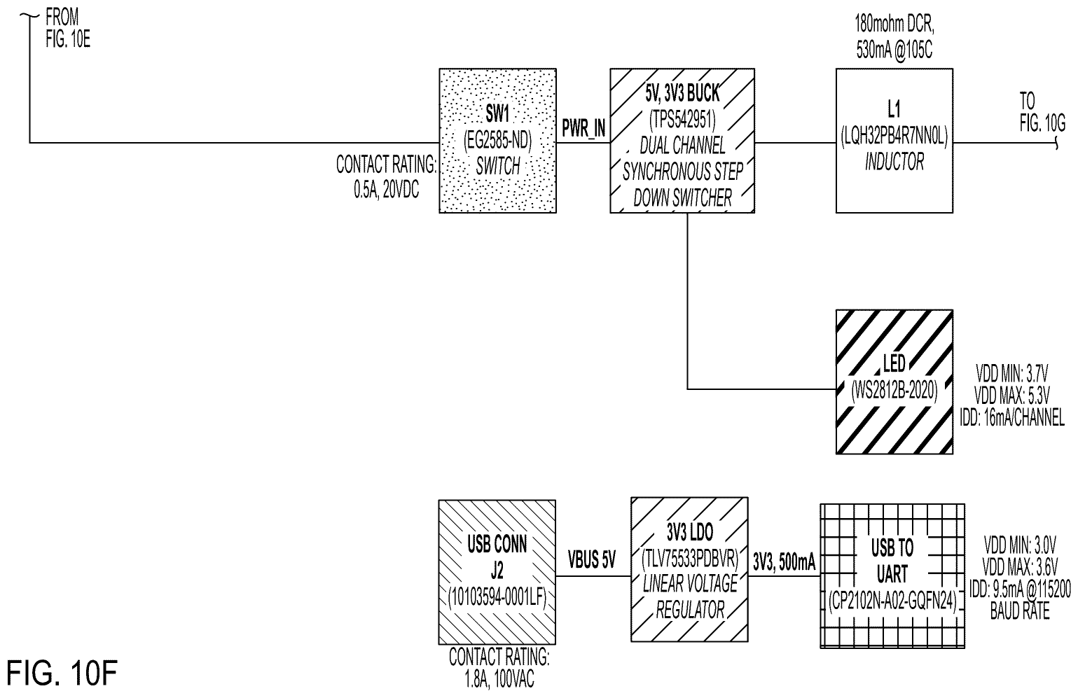

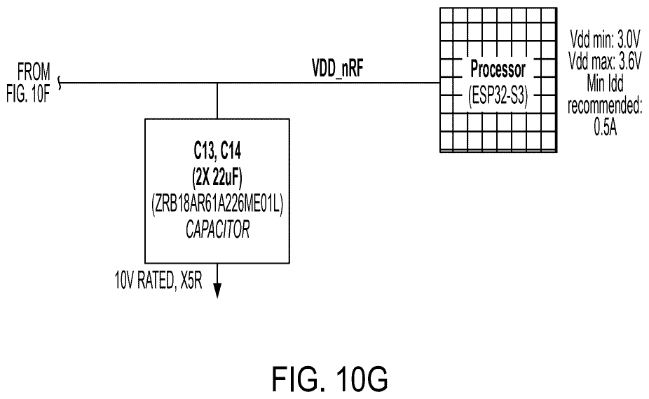

FIGS. 10A-G illustrate an exemplar power tree suitable for use with the disclosed devices. The exemplar power tree illustrates a variety of components, including exemplar part numbers and includes: a power adapter, a panel mount power adapter connector (socket), a board mount power adapter connector (socket), battery connector, one or more of each of fuses, transistors, registers, inductors, capacitor, switchers, connectors and relays. The transistors can be metal-oxide-semiconductor field-effect transistor (MOSFETs).

In engaging the systems and methods according to aspects of the disclosed subject matter a user may engage in one or more use sessions. A use session may include a training session for the user.

Any of the disclosed methods can be implemented or partially implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any device capable of a computing function that includes computing hardware). As will be appreciated by those skilled in the art, computer-readable storage media does not include communication connections, such as modulated data signals. Any of the computer-executable instructions for implementing the disclosed techniques, as well as any data created and used during implementation of the disclosed embodiments, can be stored on one or more computer-readable media (e.g., non-transitory computer-readable media, which excludes propagated signals). Additionally, the computer-executable instructions can be part of, for example, a dedicated software application (“app”) or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

Only selected aspects of the software-based implementations are described. Other details that are well known in the art are omitted. For example, it should be understood that the disclosed technology is not limited to any specific computer language or program. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the internet, the world wide web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

As will be appreciated by those skilled in the art, the systems and methods disclosed are configurable to send a variety of messages when alerts are generated. Messages include, for example, SMS and email.

### IV. EXAMPLES

### General Functionality Description

Thermally insulated delivery bags or environment control containers as described herein are operable to use a combination of heaters, fans, sensors, insulation, and communications equipment to monitor, regulate and maintain an environmental condition for a food product such as pizza and other prepared foods. More particularly thermally insulated delivery bags or environment control containers are operable to maintain a pizza with a crispy crust, melty cheese, and achieve a fresh-from-the-oven state. One or more sensor, monitor the temperature and moisture content inside of the insulated delivery bags or environment control containers. Based on continuous sensor readings, one or more heaters and one or more fans can cycle on and off to maintain temperature and moisture conditions within a preset range where the preset range is selected based on the food to be transported within thermally insulated delivery bags or environment control containers.

As discussed above, if a moisture level exceeds the pre-set target range, an exhaust fan turns on and removes the moist air from within the container of the environment control container until the moisture sensor reports that the moisture level within the environment control container has returned to an acceptable reading within the pre-set range.

If the temperature goes below the pre-set temperature range, one or some of the heaters in the environment control container turns on until the temperature sensor reports that the temperature level has returned to a temperature within the pre-set temperature range.

### Operation Example 1: Restaurant Pre-Open: Phase 1

Storage and charging: (a) the environmental controllers of the environment control container can be stored and charged by plugging the controllers into an AC power source; and (b) stacking the controllers or the controller in combination with an environment control container.

Staging: (a) environmental controllers can be snapped or attached to an environment control container and moved to a staging or order prep area within the establishment preparing the food for delivery in preparation for a first batch of delivery orders; the environment control container can be plugged in for pre-heating of the interior of the environment control containers to a temperature within a pre-set range.

Heating: (a) the environment control container can be turned on to heat the interior of the environment control container and activate environmental controls; input or revise target ranges of the temperature and/or moisture.

### Operation Example 2: Restaurant Open, Pre-Delivery: Phase 2

Environment control containers are loaded with food for delivery and a timer associated with each environment control container is activated. Kitchen crew load, for example, the pizzas into the staged environment control containers for delivery and press a button to start the timer (e.g., a time in bag button). Quality/process checks are performed to confirm the environment control container is heated and in an on state. Thereafter verification is performed: (a) verify heating function is on and LCD/phone app display shows correct minimum and/or maximum temperature and/or minimum humidity; (b) verify environmental controls are on and LCD displays a humidity and/or moisture reading. Thereafter (1) environment control container(s) are handed off to delivery drivers; (2) environment control container(s) are loaded into delivery vehicles; and/or environment control container(s) are plugged into vehicle's 12V power supply. Where the environment control container(s) are plugged in, an extension cord may be provided between the power source and the environment control container(s).

### Operation Example 3: Delivery: Phase 3

Temperature, moisture and time in the environment control container is displayed in the app as well as GPS location of the environment control container. When the internal temperature of the environment control container drops below the low end of the temperature range, the heaters are engaged. When the internal temperature exceeds the upper temperature of the temperature range, one or more of the heaters are turned off. When the internal moisture/humidity content of the environment control container is below the low end of the pre-set range, the exhaust fan is turned off. When the moisture content exceeds the high end of the range, the exhaust fan is engaged and remains on until the low end of the range is reached. Environment control container are carried to customer door same as current deliver bags and delivery is made.

### Operation Example 4: Post-delivery: Phase 4

The delivery personnel turns off the environment control container and plugs the device into vehicle's power supply, if available. This process: (a) helps to restore/maintain battery charge on the environment control container for the next delivery; and (b) upon return to the restaurant, driver unplugs environment control container and returns the device to the kitchen or restaurant staff to be returned to the staging/prep area or a storage area. Regardless of whether the environment control containers were plugged into the car's 12V, the environment control containers can be plugged into the AC outlet in the restaurant to charge and be ready for upcoming orders.

### Operation Example 5: Restaurant Pre-close: Phase 5

The environmental controllers are un-snapped and/or separated from the environment control container. The controllers are inspected for dirt and damage-wiped down/cleaned. Controllers placed in storage and plugged in to AC. environment control containers can be stacked for storage when not in use.

### Food Delivery Example 1: Use Case 1: Two Hawaiian Pizzas for Delivery in Honolulu HI

Weather Conditions: High temperature and moderately high humidity.

The challenge: deliver two pizzas with high-moisture content toppings (e.g. pineapple) to be delivered in a high humidity environment.

Expected delivery time: 22 minutes

Actual delivery time: 35 minutes

Once the environment control container has reached target heating temperature, it will maintain that temperature in the staging area until the order comes out of the oven. Once ready, the two Hawaiian pizzas are loaded into their boxes. The boxes are then loaded into the environment control container. The software app begins actively controlling the environment inside the environment control container by monitoring the sensor readings and controlling the heaters, fans and vents.

Targets have been set for both temperature and moisture content. For example, the temperature target is a range, between 70 C-75 C. Humidity target is set with an upper limit, 15%. When the pizzas are first loaded into thermally insulated bag, the internal temperature drops due to the total mass of the pizza and the air within the boxes being cooler than the pre-load internal environment of the Environment control container. Therefore, all heaters including the intake heater with fan are on high to return the internal temperature to its target range. Also, because the pizzas are giving off very high levels of moisture in the form of steam, the exhaust fan is engaged on a high speed to evacuate the moisture as quickly as possible to prevent the moisture from being absorbed by the crispy crust of the pizza. In this example, the environment control container, is loaded into the vehicle, placed on the passenger seat but not plugged in as the charger in this delivery car is broken.

The environment control container is now in maintenance mode, the environment control container's heaters and fans are engaging or disengaging based on sensor readings from the internal sensors, keeping the temperature and moisture levels within the pre-set range. As the environment control container is carried outside into the high heat, the rate of cooling inside thermally insulated bag is reduced and therefore the heaters are engaged less frequently. Because of the relatively high humidity outside, combined with the two high-moisture style pizzas in the environment control container, the exhaust fan is engaged quite frequently and at higher speeds to keep up with the high levels of moisture. Due to the exhaust fan running at higher speeds and more frequently, the environment control container also loses more heat and falls outside the temperature range. Therefore the heaters are engaged to compensate for the heat loss, despite the high temps outside. This process of exhausting the moisture and heating the environment control container repeats, based on readings, until the pizzas are removed from the environment control container and the delivery is complete. Unexpected traffic caused the delivery to take 13 minutes longer than expected, which was not a problem and did not negatively impact the food quality as the lithium ion powered environment control container kept the temperature and moisture conditions within the needed range for more than an hour, unplugged from a power source. Once the delivery is made, the environment control container is turned off and placed back in the vehicle for the return trip to the pizzeria. Upon return, the environment control container is plugged in for re-charging for the next delivery.

### Food Delivery Example 2: A Large Fungi Pizza in Fargo ND During Winter

Weather Conditions in Fargo North Dakota: Below freezing (20 F) and very low humidity. The challenge: deliver one thin crust pizza with mushrooms (not a lot of mass for maintaining heat).

The environment control container has reached target heating temperature and is maintaining that temperature in the staging area until the order comes out of the oven. The pizza is then loaded into the box, which is then loaded into the environment control container. The software app begins actively controlling the environment inside the environment control container. Targets have been set for both temperature and moisture content.

Temperature target is a range, between 75 C-80 C.

Humidity target is an upper limit, 20%.

The environment control container, is loaded into the vehicle, placed on the passenger seat and plugged in to the car's 12V power supply. Now in maintenance mode, the environment control container's heaters and fans are engaging or disengaging based on readings from the internal sensors, keeping the temperature and moisture levels within the environment control container within range. As the environment control container is carried outside into the freezing temperatures, the rate of cooling inside the environment control container is increased and therefore the heaters are engaged more frequently. Because of the relatively low humidity outside, the exhaust fan is engaged less frequently and at lower speeds to evacuate the moisture as needed. In spite of the exhaust fan running at lower speeds and less frequently, the environment control container loses heat at a high rate due to the freezing conditions outside and falls outside the temperature range. Therefore the heaters are engaged to compensate for the heat loss, including the intake heater and fan. This process of exhausting the moisture (i.e., removing moisture via the exhaust fan) and heating the environment control container repeats, based on sensor readings, until the pizzas are removed from the environment control container and the delivery is complete. Once the delivery is made, the environment control container is turned off and placed back in the vehicle and plugged back in for the return trip to the pizzeria. Upon return, the environment control container is sent directly to staging since it's fully charged and ready to make another delivery.

### Food Delivery Example 3: Two pepperoni pizzas in Palm Beach FL

Weather conditions: Low 90's with tropical thunderstorms.

The challenge: maintain optimal moisture content in the environment control container despite near 100% humidity combined with rain. The environment control container has reached target heating temperature and is maintaining that temperature in the staging area until the order comes out of the oven. The pizzas are loaded into their boxes, which are then loaded into the environment control container.

The software app begins actively controlling the environment inside the environment control container.

Targets have been set for both temperature and moisture content.

Temperature target is a range, between 70 C-75 C.

Humidity target has an upper limit of 10%.

The environment control container, is loaded into the vehicle, placed on the passenger seat and plugged in to the car's 12V power supply. Now in maintenance mode, the heaters and fans are engaging or disengaging based on readings from the internal sensors, keeping the temperature and moisture levels within the pre-set range. As the environment control container is carried outside in the tropical thunderstorm, the extremely high humidity causes the exhaust fan to turn on at the highest speed and remain on with only very short pauses when the internal moisture content drops below the target range. Due to the exhaust fan being on high nearly constantly, the environment control container also loses a lot of heat, despite the outside temperature being above 90 F. The internal air temperature needs to be ˜160 F+. Therefore, all three heaters including the intake fan remain on with only short pauses when the temperature inside the environment control container reaches its target range. Although the intake fan is pulling in high-humidity air, the effect is mitigated by passing the air across the heater. The use of the heater with the intake fan makes it harder for moisture to settle in the crust before being evacuated by the exhaust fan. This process of exhausting the moisture (e.g., removing the moisture) and heating the environment control container repeats, based on sensor readings, until the pizzas are removed from the environment control container and the delivery is complete. The delivery is made, the environment control container is turned off and placed back in the vehicle and plugged back in for the return trip to the pizzeria. Upon return, the environment control container is sent directly to staging since it's fully charged again.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that any claims presented define the scope of the invention and that methods and structures within the scope of these claims and their equivalents be covered thereby.

What is claimed:

1. A portable container comprising:
an enclosure having an openable section, the openable section operable to change between an open position and a closed position, and a plurality of exterior surfaces and interior surfaces;
an environmental control module securable to a first side surface of the portable container, the environmental control module operable to be in communication with one or more environmental controllers and one or more environmental sensors;
a shelf positionable within an interior cavity of the portable container;
a heater positioned within the interior cavity of the portable container;
an intake fan; and
a power supply in communication with the environmental control module.

2. The portable container of claim 1 wherein the environmental control module is operable to communicate one or more sensed environmental conditions and to adjust one or more environmental controllers in response to the one or more sensed environmental conditions.

3. The portable container of claim 1 wherein the one or more environmental sensors are selected from temperature sensors, moisture sensors, humidity sensors, atmospheric pressure sensors, oxygen sensors, air quality sensors, smoke sensors.

4. The portable container of claim 3 wherein more than one of any of the one or more environmental sensors is provided.

5. The portable container of claim 3 wherein the one or more environmental sensors are positioned within the portable container at a location away from the one or more environmental controllers.

6. The portable container of claim 1 further comprising one or more of a GPS sensor and a G-force sensor.

7. The portable container of claim 1 further comprising a communication device for transmitting sensor information from one or more sensors and receiving environment control instructions in response to the transmitted sensor information.

8. The portable container of claim 1 further comprising a pouch securable to an inside surface of the plurality of interior surfaces of the enclosure wherein the pouch has a pouch interior chamber accessible via a pouch opening.

9. The portable container of claim 8 further comprising at least one heating element positionable within the pouch interior chamber.

10. The portable container of claim 1 further comprising one or more exhaust fans.

11. The portable container of claim 1 wherein the intake fan has a heater element.

12. The portable container of claim 1 wherein the shelf has a plurality of apertures.

13. The portable container of claim 1 further comprising at least one of a flange, flap or ridge extending from the interior surface of the enclosure.

14. The portable container of claim 13 wherein a surface of the at least one flange, flap or ridge has a flap strip of hook and loop fastener adhered to a surface of the at least one flange, flap or ridge.

15. The portable container of claim 14 wherein the shelf has a strip of hook and loop fastener adhered to a shelf surface operable to engage the flap strip of hook and loop fastener.

16. A transportation method comprising:
providing a portable container having an openable section, the openable section operable to change between an open position and a closed position, and a plurality of interior exterior surfaces and interior surfaces, an environmental control module securable to a first side surface of the portable container, the environmental control module operable to be in communication with one or more environmental controllers and one or more environmental sensors, a shelf positionable within the interior of the portable container, a heater positioned within an interior cavity of the portable container, an intake fan, and a power supply in communication with the environmental control module;
opening the portable container;
placing a food container within the portable container for transport;
closing the portable container;
configuring the environmental control module to maintain an environment within the container based on an identification of food within the food container; and
transporting the portable container.

17. The transportation method of claim 16 further comprising determining a GPS location for the portable container.

18. The transportation method of claim 16 further comprising determining a G-force for the portable container.

19. The transportation method of claim 16 further comprising the step of determining if the portable container has maintained one or more environmental conditions during transport, and if the portable container has maintained the one or more environmental conditions, delivering the food container.

20. The transportation method of claim 16 further comprising the step of determining if the portable container has been subjected to any G-force during transport, and if the portable container has not been subjected to any G-force, delivering the food container.

21. The transportation method of claim 16 further comprising the step of determining if the portable container has been subjected to any G-force during transport, and if the portable container has been subjected to any G-force, determining whether the G-force is within a predetermined range of allowable G-force, and if the G-force is within the predetermined range of allowable G-force, delivering the food container.

22. A portable container comprising:
a first soft-sided enclosure having an openable section, the openable section operable to change from an open position to a closed position, and a plurality of interior surfaces and exterior surfaces;
a second hard-sided enclosure having an openable section, sized to fit within the first soft-sided enclosure;
an environmental control module wherein the environmental control module is in communication with one or more environmental controllers and one or more environmental sensors; and
a power supply in communication with the environmental control module.
